(19) United States
(12) Patent Application Publication
(10) Pub. No.: US 2025/0206654 A1
(43) Pub. Date: Jun. 26, 2025

(54) OPTICAL FIBER MANUFACTURING METHOD AND OPTICAL FIBER DRAWING DEVICE

(71) Applicant: SUMITOMO ELECTRIC INDUSTRIES, LTD., Osaka-shi, Osaka (JP)

(72) Inventors: Kazuhiro YONEZAWA, Tochigi (JP); Satoshi IWAHARA, Tochigi (JP)

(21) Appl. No.: 18/851,850

(22) PCT Filed: Mar. 29, 2023
(86) PCT No.: PCT/JP2023/013024

§ 371 Date: Sep. 27, 2024

(30) Foreign Application Priority Data
Mar. 30, 2022 (JP) 2022-055713

(51) Int. Cl. C03B 37/027; C03B 37/029

(52) U.S. Cl. CPC C03B 37/02718; C03B 37/029

(57) ABSTRACT

In an optical fiber manufacturing method, an optical fiber base material is heated and melted in a drawing furnace and is drawn to form a glass fiber. The drawing furnace includes a heating furnace configured to heat and melt an optical fiber base material, and a lower extension tube provided at a lower end of the heating furnace and through which the glass fiber passes. The lower extension tube has a fiber outlet from which the glass fiber comes out. Drawing is performed while the fiber outlet is covered in an atmosphere with a dew point temperature of 10° C. or lower.

### TECHNICAL FIELD

The present disclosure relates to an optical fiber manufacturing method and an optical fiber drawing device.

The present application claims priority from Japanese Patent Application No. 2022-055713 filed on Mar. 30, 2022, the entire contents of which are incorporated herein by reference.

### BACKGROUND ART

Patent Literature 1 discloses an optical fiber drawing furnace in which a lower extension tube is provided below a core tube into which a glass base material for an optical fiber is inserted. In the drawing furnace, a part of a first inert gas introduced into the core tube and flowing into the lower extension tube is recovered in the lower extension tube. A gas screen is provided below the lower extension tube. In order to prevent atmospheric air from entering the lower extension tube due to the recovery of the part of the first inert gas, a second inert gas is supplied to the inside of the gas screen.

### CITATION LIST

### Patent Literature

Patent Literature 1: US2017/101336 A1

### SUMMARY OF INVENTION

An optical fiber manufacturing method according to an aspect of the present disclosure is an optical fiber manufacturing method including:
in a drawing furnace, heating and melting an optical fiber base material and drawing the optical fiber base material to form a glass fiber, in which
the drawing furnace includes
a beating furnace configured to heat and melt an optical fiber base material, and
a lower extension tube provided at a lower end of the heating furnace and through which the glass fiber passes.
the lower extension tube has a fiber outlet from which the glass fiber comes out, and
drawing is performed while the fiber outlet is covered in an atmosphere with a dew point temperature of 10° C. or lower.

An optical fiber drawing device according to another aspect of the present disclosure is an optical fiber drawing device that heats and melts an optical fiber base material and draws the optical fiber base material to form a glass fiber, the drawing device including:
a heating furnace configured to heat and melt the optical fiber base material;
a lower extension tube provided at a lower end of the heating furnace and through which the glass fiber passes and comes out from a fiber outlet;
a booth surrounding the fiber outlet and having a supply opening through which an inert gas is supplied into the booth; and
an inert gas generation unit configured to generate the inert gas and supply the generated inert gas to the supply opening.

### Advantageous Effects of Invention

According to the configuration of the present disclosure, it is possible to prevent adhesion of moisture contained in the atmospheric air to a glass fiber coming out from a fiber outlet of a drawing furnace, and to reduce a decrease in the strength of an obtained optical fiber.

### BRIEF DESCRIPTION OF DRAWINGS

FIG. 1 is a schematic configuration diagram of an optical fiber manufacturing device according to an embodiment of the present disclosure.

FIG. 2 is a partially enlarged view showing a part of a lower extension tube shown in FIG. 1.

FIG. 3 is a partially enlarged view showing a modification of the optical fiber manufacturing device.

FIG. 4 is a partially enlarged view showing another modification of the optical fiber manufacturing device.

FIG. 5 is a schematic perspective view of a booth according to the modification shown in FIG. 4.

### DESCRIPTION OF EMBODIMENTS

### Problem to be Solved by Present Disclosure

In the optical fiber drawing furnace, when moisture contained in the atmospheric air adheres to a glass fiber coming out from a fiber outlet of the drawing furnace, the strength of an obtained optical fiber may be decreased.

An object of the present disclosure is to prevent adhesion of moisture contained in the atmospheric air to a glass fiber coming out from a fiber outlet of a drawing furnace, and to reduce a decrease in the strength of an obtained optical fiber.

### DESCRIPTION OF EMBODIMENTS OF PRESENT DISCLOSURE

First, aspects of the present disclosure will be listed and described.

(1) An optical fiber manufacturing method according to an aspect of the present disclosure is an optical fiber manufacturing method including:
in a drawing furnace, heating and melting an optical fiber base material and drawing the optical fiber base material to form a glass fiber, in which
the drawing furnace includes
a heating furnace configured to heat and melt an optical fiber base material, and
a lower extension tube provided at a lower end of the heating furnace and through which the glass fiber passes,
the lower extension tube has a fiber outlet from which the glass fiber comes out, and
drawing is performed while the fiber outlet is covered in an atmosphere with a dew point temperature of 10° C. or lower.

According to the method, it is possible to prevent adhesion of moisture contained in the atmospheric air to a glass fiber coming out from a fiber outlet of a drawing furnace, and to reduce a decrease in the strength of an obtained optical fiber.

(2) In the above (1).
the heating furnace may have a gas inlet through which a gas containing helium gas is introduced into the heating furnace,
the lower extension tube may have a gas suction opening though which a gas containing helium gas in the lower extension tube is sucked out and discharged to the outside of the lower extension tube, and
drawing may be performed while the gas containing helium gas discharged from the gas suction opening is regenerated for reuse.

When the helium gas is sucked from the lower extension tube, the amount of the helium gas flowing out from the fiber outlet together with the glass fiber is decreased, and the glass fiber coming out from the fiber outlet is easily exposed to the atmospheric air. According to the above method, the fiber outlet is covered in an atmosphere with a dew point temperature of 10° C. or lower, so that moisture in the atmospheric air is prevented from adhering to the glass fiber. Accordingly, the decrease in the strength of the optical fiber can be reduced while the expensive helium gas can be reused.

(3) In the above (1) or (2), a temperature of the glass fiber coming out from the fiber outlet may be 1300° C. or more and 1700° C. or less.

As the temperature of the glass fiber coming out from the fiber outlet of the lower extension tube increases, a reaction between the moisture in the atmospheric air and a surface of the glass fiber is accelerated, and the surface of the glass fiber is easily damaged. According to the above method, even when the glass fiber comes out from the fiber outlet at a high temperature of 1300° C. or higher, the fiber outlet is covered in an atmosphere with a dew point temperature of 10° C. or lower, so that the moisture in the atmospheric air is prevented from adhering to the glass fiber. Thereby, a decrease in the strength of the optical fiber can be reduced. In addition, by setting the coming-out temperature of the glass fiber equal to or higher than 1300° C., it is possible to prevent a situation in which the glass fiber is rapidly cooled and varies in outer diameter before the glass fiber comes out from the fiber outlet of the lower extension tube. Further, by setting the coming-out temperature of the glass fiber to 1700° C. or lower, it is possible to prevent the generation of a defect on the surface of the glass fiber due to a collision with dust in the atmospheric air. As a result, a decrease in the strength of the optical fiber can be further reduced.

(4) In any one of the above (1) to (3), an inert gas may be supplied around the fiber outlet.

According to this method, the fiber outlet of the lower extension tube can be effectively covered in an atmosphere with a dew point temperature of 10° C. or lower. Further, when the inert gas is used, atmospheric air can be prevented from entering the lower extension tube. As a result, a decrease in the strength of the optical fiber can be further reduced.

(5) In any one of the above (1) to (4), an inert gas may be supplied into a booth surrounding the fiber outlet.

According to this method, the fiber outlet of the lower extension tube can be more effectively covered in an atmosphere with a dew point temperature of 10° C. or lower.

(6) In the above (5),
the booth may have a first side surface and a second side surface facing the first side surface, and
the inert gas may be supplied from the first side surface and discharged from the second side surface.

According to this method, a flow of the inert gas is formed in the booth. As a result, dust and gases such as dicyan ejected in the drawing furnace is less likely to remain.

(7) An optical fiber drawing device according to an aspect of the present disclosure is an optical fiber drawing device that heats and melts an optical fiber base material and draws the optical fiber base material to form a glass fiber, the drawing device including:
a heating furnace configured to heat and melt the optical fiber base material;
a lower extension tube provided at a lower end of the heating furnace and through which the glass fiber passes and comes out from a fiber outlet;
a booth surrounding the fiber outlet and having a supply opening through which an inert gas is supplied into the booth; and
an inert gas generation unit configured to generate the inert gas and supply the generated inert gas to the supply opening.

According to the drawing device of the present disclosure, the inert gas is generated from the inert gas generation unit, and the inert gas is supplied from the supply opening into the booth, so that the moisture contained in the atmospheric air is prevented from adhering to the glass fiber coming out from the fiber outlet, and a decrease in the strength of the obtained optical fiber can be reduced.

(8) In the above (7), a plate may be provided between the supply opening and a position inside the booth though which the glass fiber passes.

According to this configuration, the inert gas does not directly hit the glass fiber, so that deflection of the glass fiber can be prevented.

(9) In the above (7) or (8), an opening and closing door may be provided on a front surface of the booth.

The opening and closing door is provided in the booth, so that it is easy to initially draw a glass fiber from an optical fiber base material (so-called gob dropping work).

### Effects of Present Disclosure

According to the configuration of the present disclosure, it is possible to prevent adhesion of moisture contained in the atmospheric air to a glass fiber coming out from a fiber outlet of a drawing furnace, and to reduce a decrease in the strength of an obtained optical fiber.

### DETAILS OF EMBODIMENTS OF PRESENT DISCLOSURE

Hereinafter, examples of embodiments of a manufacturing device and a manufacturing method for an optical fiber according to the present disclosure will be described with reference to the drawings. In the following description, the same or equivalent elements are denoted by the same reference numerals or names even in different drawings, and redundant description will be appropriately omitted. The dimensions of the members shown in the drawings are for convenience of description and may be different from actual dimensions of the members.

### (Optical Fiber Manufacturing Device)

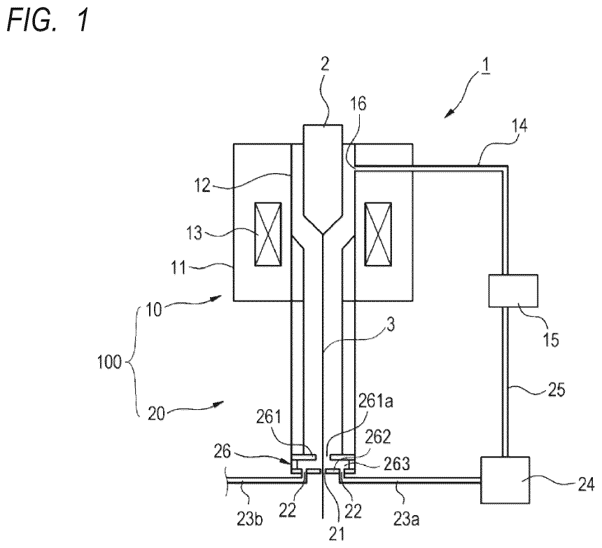

FIG. 1 is a schematic configuration diagram of an optical fiber manufacturing device 1 according to an embodiment of the present disclosure. The manufacturing device 1 includes a drawing furnace 100. The drawing furnace 100 is a device that heats and melts an optical fiber base material 2 and draws the optical fiber base material 2 to form a glass fiber 3. Although not shown, the manufacturing device 1 may further include a cooling device that cools the glass fiber 3, a coating device that applies a coating resin to an outer periphery of the glass fiber 3, a winding device that winds the glass fiber 3 coated with the coating resin, and the like. The drawing furnace 100 is an example of an optical fiber drawing device.

The drawing furnace 100 includes a heating furnace 10 and a lower extension tube 20. The heating furnace 10 heats and melts the optical fiber base material 2. The heating furnace 10 includes a housing 11, a core tube 12, and a heater 13. The housing 11 is configured to surround the core tube 12 and the heater 13. The heater 13 is disposed so as to surround the core tube 12. A heat insulating material (not shown) is disposed between the heater 13 and the housing 11. The optical fiber base material 2 is suspended within the core tube 12 by a base material suspension mechanism (not shown). A lower portion of the suspended optical fiber base material 2 is melt by heat from the heater 13, so that the glass fiber 3 having a predetermined outer diameter is continuously obtained by drawing.

The core tube 12 has a gas inlet 16. One end of a gas pipe 14 is connected to the gas inlet 16. The other end of the gas pipe 14 is connected to an inert gas supply unit 15 for supplying an inert gas such as argon gas, helium gas, nitrogen gas and the like. The inert gas supplied from the inert gas supply unit 15 is supplied through the gas pipe 14 into the core tube 12 from the gas inlet 16. The inert gas supplied into the core tube 12 flows into the lower extension tube 20.

The lower extension tube 20 is provided at a lower end of the heating furnace 10. The lower extension tube 20 is provided such that an inlet of the lower extension tube 20 and an outlet of the core tube 12 are connected to each other. For example, the lower extension tube 20 is preferably provided so as to be in close contact with a lower side of the heating furnace 10. The lower extension tube 20 may be integrally formed with the heating furnace 10 or may be detachably provided to the heating furnace 10. A fiber outlet 21 is formed at a lower end of the lower extension tube 20. The glass fiber 3 drawn in the core tube 12 continuously passes through the inside of the lower extension tube 20 and comes out from the fiber outlet 21. By providing the lower extension tube 20, it is possible to prevent rapid cooling of the heated and softened glass fiber 3, and to prevent variation in outer diameter of the glass fiber 3 by cooling and curing the glass fiber 3 to some extent.

The lower extension tube 20 has a gas suction opening 22. The gas suction opening 22 is provided for the purpose of sucking a mixed gas containing an inert gas supplied into the core tube 12 and flowed into the lower extension tube 20 and another gas containing impurities and the like generated in a drawing process, and discharging the mixed gas to the outside of the lower extension tube 20. In the example of FIG. 1, two gas suction openings 22 are provided. One end of a gas pipe 23a is connected to one of the gas suction openings 22. One end of a gas pipe 23b is connected to the other one of the gas suction openings 22. Although illustration of a part of the gas pipe 23b is omitted, a gas regeneration device 24 is connected to the other ends of the gas pipes 23a and 23b. The gas regeneration device 24 separates and purifies an inert gas (for example, helium gas) from the mixed gas sucked through the gas suction opening 22, and regenerates the inert gas into a reusable state. The gas regeneration device 24 and the inert gas supply unit 15 may be connected by a pipe 25, and the inert gas regenerated by the gas regeneration device 24 may be supplied to the inert gas supply unit 15.

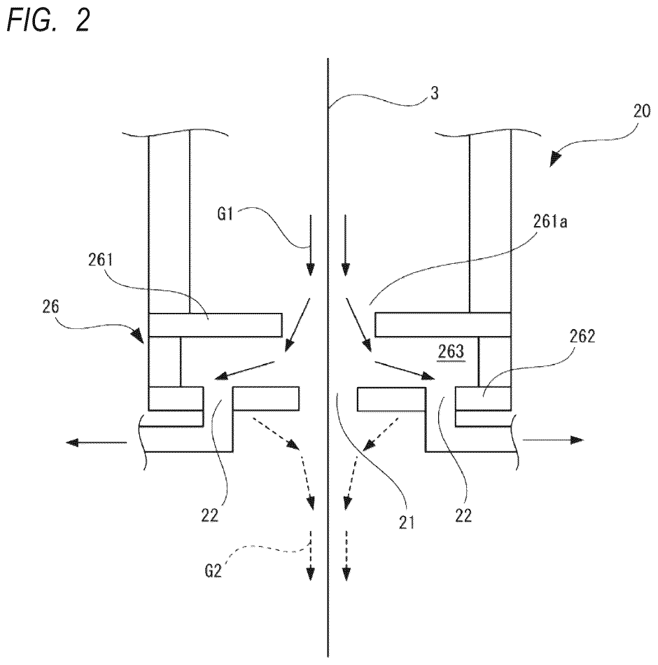

In the example of FIG. 1, the lower extension tube 20 includes a shutter mechanism 26. As shown in FIG. 2, the shutter mechanism 26 includes an upper shutter 261 and a lower shutter 262. A gas recovery space 263 is formed between the upper shutter 261 and the lower shutter 262. A mixed gas G1 passed through a passage hole 261a of the upper shutter 261 and collected in the gas recovery space 263 is sucked to the outside from the gas recovery space 263 through the gas suction opening 22 formed in a bottom surface of the lower shutter 262.

The fiber outlet 21 formed in the center of the bottom surface of the lower shutter 262 is covered in an atmosphere with a dew point temperature of 10° C. or lower. For example, as shown in FIG. 2, gas G2 whose dew point temperature is controlled to 10° C. or lower is supplied around the fiber outlet 21.

### (Optical Fiber Manufacturing Method)

Subsequently, an optical fiber manufacturing method using the manufacturing device 1 shown in FIG. 1 will be described as the optical fiber manufacturing method according to the present embodiment.

The optical fiber manufacturing method according to the present embodiment includes a first step of heating and melting the optical fiber base material 2 in the heating furnace 10, a second step of causing the glass fiber 3 coming out of the heating furnace 10 to pass through the lower extension tube 20, and a third step of causing the glass fiber 3 to come out from the fiber outlet 21 covered in an atmosphere with a dew point temperature of 10° C. or less.

In the first step, the optical fiber base material 2 is suspended in the core tube 12, and the lower portion of the optical fiber base material 2 is heated and melt by the heater 13. The melted optical fiber base material 2 is continuously drawn into the glass fiber 3 having a predetermined outer diameter due to the weight and tensile force of the molten glass. In the first step, an inert gas is introduced into the core tube 12 from the gas inlet 16. The inert gas described above may be used. Hereinafter, a case where helium gas is used as the inert gas will be described.

In the core tube 12, for example, silica particles formed by a silica component volatilized from the optical fiber base material 2, carbon particles peeled off from a carbon part used in the heating furnace 10, and the like are constantly generated. These impurities are carried to the lower extension tube 20 by a towed flow of the inert gas.

In the second step, the glass fiber 3 coming out from the heating furnace 10 (core tube 12) passes through the lower extension tube 20. By passing through the inside of the lower extension tube 20, the glass fiber 3 is not rapidly cooled, and is cooled and cured to some extent, so that variations in the outer diameter are prevented. Further, in the second step, the mixed gas G1 containing the helium gas in the lower extension tube 20 and the other gas containing impurities and the like generated in the first step and the second step is sucked from the gas suction opening 22. The sucked mixed gas is separated and purified by the gas regeneration device 24, thereby being regenerated as reusable helium gas.

In the third step, the glass fiber 3 passed through the lower extension tube 20 comes out from the fiber outlet 21 covered in an atmosphere with a dew point temperature of 10° C. or lower. For example, by supplying a gas G2 whose dew point temperature is controlled to be 10° C. or lower around the fiber outlet 21, the fiber outlet 21 is covered in an atmosphere with a dew point temperature of 10° C. or lower. The glass fiber 3 coming out from the fiber outlet 21 passes through an atmosphere with a dew point temperature of 10° C. or lower.

In some cases, moisture contained in the atmospheric air may adhere to the glass fiber 3 coming out from the fiber outlet 21 of the lower extension tube 20, which may decrease the strength of the glass fiber 3. In particular, when the dew point temperature of the area where the optical fiber manufacturing device is installed is high, more moisture adheres to the glass fiber 3, which increases the frequency of breakage of the obtained optical fiber.

Table 1 shows a relationship between the dew point temperature of the area where the optical fiber manufacturing device is installed and the frequency of fiber breakage. In a state where the same device as the optical fiber manufacturing device 1 was used and the dew point temperature of the fiber outlet 21 was not controlled, facilities A to E were prepared in which coming-out temperature of the glass fiber 3 and the recovery of the helium gas were varied, and the frequency of breakage of the optical fiber was evaluated when the dew point temperature of the area was changed. The frequency of fiber breakage indicates the number of fiber breakages that occur per 1000 km of the optical fiber when a screening test is performed in the process after drawing.

TABLE 1

| | Fiber | | | | | | | | | | | | | |
|---|---|---|---|---|---|---|---|---|---|---|---|---|---|---|
| | coming- | Re- | | | | | | | | | | | | |
| | out tem- | covery | Air dew point temperature [° C.] | | | | | | | | | | | |
| Facility | perature | of He | 1.59 | 2.38 | 3.61 | 3.76 | 5.80 | 7.15 | 10.70 | 11.44 | 13.29 | 13.94 | 14.19 | 15.04 |
| A | 1220 | ON | 0.57 | 0.56 | 0.57 | 0.56 | 0.56 | 0.59 | 0.60 | 0.59 | 0.58 | 0.64 | 0.60 | 0.66 |
| B | 1340 | ON | 0.60 | 0.66 | 0.64 | 0.71 | 0.65 | 0.70 | 0.70 | 0.67 | 0.65 | 0.72 | 0.64 | 0.61 |
| C | 1500 | ON | 0.82 | 0.88 | 0.79 | 0.80 | 0.82 | 0.86 | 0.91 | 0.92 | 0.94 | 0.96 | 1.04 | 1.94 |
| D | 1570 | ON | 0.89 | 0.95 | 0.97 | 1.21 | 1.08 | 0.99 | 1.21 | 1.01 | 2.59 | 3.33 | 3.21 | 4.51 |
| E | 1570 | OFF | 0.83 | 0.79 | 0.88 | 0.90 | 0.89 | 0.88 | 0.92 | 1.04 | 1.21 | 1.33 | 1.40 | 1.66 |

[Number/1000 km]

As shown in Table 1, it was found that when the dew point temperature of the area was low, the frequency of fiber breakage was stable in all facilities A to E. On the other hand, it was found that when the dew point temperature of the area was high, the frequency of fiber breakage was high in the facilities (the facilities C and D) in which the coming-out temperature of the glass fiber 3 was high. In addition, it was found that when the coming-out temperature of the glass fibers 3 were the same (the facilities D and E), an increase of the frequency of fiber breakage when the dew point temperature was high was reduced in the facility in which the recovery of the helium gas was not performed (the facility E).

As described above, according to the optical fiber manufacturing method of the present disclosure, drawing is performed while the fiber outlet 21 of the lower extension tube 20 is covered in an atmosphere with a dew point temperature of 10° C. or lower. Therefore, it is possible to prevent moisture in the atmospheric air from adhering to the glass fiber 3 coming out from the fiber outlet 21 of the lower extension tube 20 regardless of the dew point temperature of the area where the optical fiber manufacturing device 1 is installed and the coming-out temperature of the glass fiber. As a result, a surface of the glass fiber 3 is less likely to be damaged, and a decrease in the strength of the obtained optical fiber can be prevented.

Further, when the helium gas introduced into the heating furnace 10 is recovered and reused, as shown in Table 1, the frequency of fiber breakage increases as compared with a case where the helium gas is not recovered. It is considered that this is because the amount of the helium gas flowing out from the fiber outlet 21 is decreased, and the glass fiber 3 is more easily exposed to the atmospheric air. However, as described above, the fiber outlet 21 is covered in an atmosphere with a dew point temperature of 10° C. or lower, so that moisture in the atmospheric air is prevented from adhering to the glass fiber 3. Accordingly, the decrease in the strength of the optical fiber can be reduced while the expensive helium gas can be reused.

It is preferable that the temperature of the glass fiber 3 coming out from the fiber outlet 21 is 1300° C. or higher. Further, it is preferable that the temperature of the glass fiber 3 coming out from the fiber outlet 21 is 1700° C. or lower. The temperature of the glass fiber 3 when coming out from the fiber outlet 21 can be controlled by, for example, changing a length of the lower extension tube 20 or changing a temperature, a flow rate, and the like of the helium gas.

As the coming-out temperature of the glass fiber 3 increases, a reaction between the moisture in the atmospheric air and a surface of the glass fiber is accelerated. Therefore, the frequency of fiber breakage is increased as shown in Table 1. However, even when the glass fiber 3 comes out from the fiber outlet 21 at a high temperature of 1300° C. or higher, the fiber outlet 21 is covered in an atmosphere with a dew point temperature of 10° C. or lower, so that moisture is prevented from adhering to the glass fiber 3. In addition, by setting the coming-out temperature of the glass fiber 3 equal to or higher than 1300° C. it is possible to prevent a situation in which the glass fiber 3 is rapidly cooled and varies in outer diameter before the glass fiber 3 comes out from the fiber outlet 21 of the lower extension tube 20. Further, by setting the coming-out temperature of the glass fiber 3 to 1700° C. or lower, it is possible to prevent the generation of a defect on the surface of the glass fiber due to a collision with dust in the atmospheric air.

In this example, the gas G2 whose dew point temperature is controlled to be 10° C. or lower is supplied around the fiber outlet 21. Thus, the fiber outlet 21 can be efficiently covered in an atmosphere with a dew point temperature of 10° C. or lower. Examples of the gas G2 include inert gases such as argon gas and nitrogen gas. When the inert gas is used, atmospheric air can be prevented from entering the lower extension tube 20.

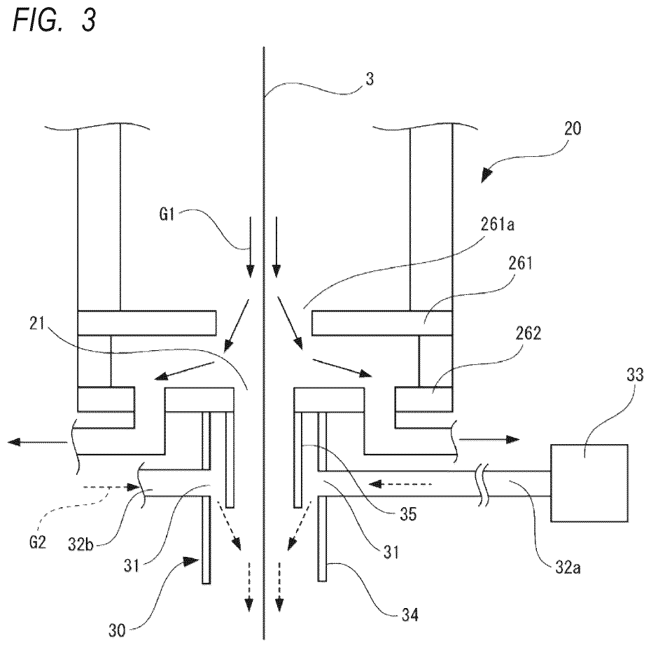

As a configuration for supplying the gas G2 around the fiber outlet 21, the optical fiber manufacturing device 1 may include a gas purge tube 30, as shown in FIG. 3, for example. The gas purge tube 30 is provided at the lower end of the lower extension tube 20. The gas purge tube 30 is provided such that an outlet of the lower extension tube 20 and an inlet of the gas purge tube 30 are connected to each other, and is preferably provided, for example, in close contact with the lower extension tube 20. The gas purge tube 30 may be integrally formed with the lower extension tube 20 or may be detachably provided to the lower extension tube 20. The glass fiber 3 coming out from the fiber outlet 21 of the lower extension tube 20 continuously passes through the gas purge tube 30.

The gas purge tube 30 has a gas inlet 31. The gas inlet 31 is provided to supply the gas G2 into the gas purge tube 30. In the example of FIG. 3, two gas inlets 31 are provided. A first end portion of a gas pipe 32a is connected to one of the gas inlets 31. A first end portion of a gas pipe 32b is connected to the other one of the gas inlets 31. Although illustration of a part of the gas pipe 32b is omitted, a gas supply unit 33 is connected to second end portions of the gas pipes 32a and 32b. The gas G2 supplied from the gas supply unit 33 is supplied through the gas pipes 32a and 32b into the gas purge tube 30 from the gas inlet 31. The gas G2 supplied into the gas purge tube 30 is supplied around the glass fiber 3 passing through the gas purge tube 30.

In the example of FIG. 3, the gas purge tube 30 includes an outer wall 34 and an inner wall 35. The inner wall 35 is provided inside the outer wall 34. A double pipe structure is formed by the outer wall 34 and the inner wall 35. Specifically, the outer wall 34 and the inner wall 35 each form a tube extending along a propagating direction of the glass fiber 3. There is a cavity between the outer wall 34 and the inner wall 35. The inner wall 35 has a length shorter than that of the outer wall 34. The gas inlet 31 is provided above a lower end of the inner wall 35 in the outer wall 34. According to such a configuration, the inner wall 35 prevents the gas G2 introduced from the gas inlet 31 from directly hitting the glass fiber 3. That is, the gas G2 introduced into the gas purge tube 30 collides with the inner wall 35 and is diffused into the gas purge tube 30.

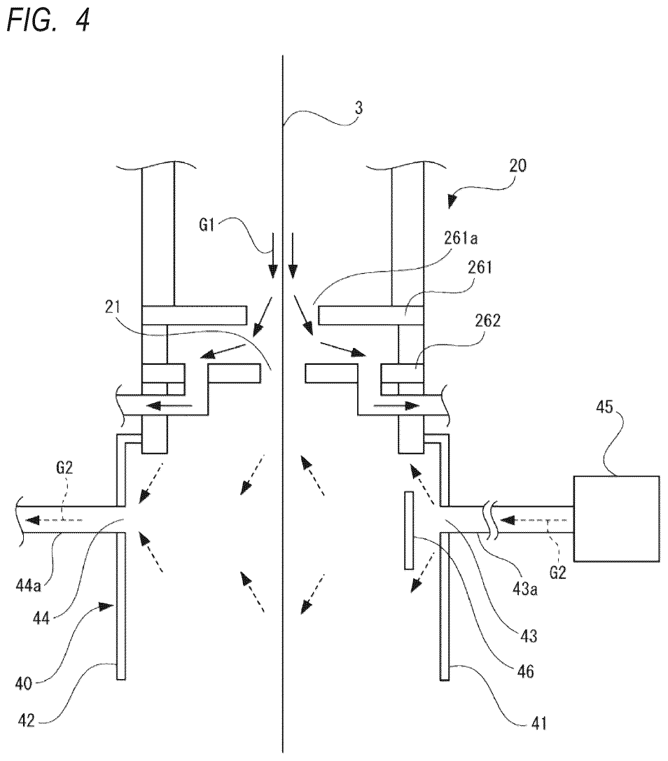

The gas G2 may be supplied around the fiber outlet 21 using a configuration other than the gas purge tube 30. As another configuration for supplying the gas G2 around the fiber outlet 21, the optical fiber manufacturing device 1 may include a booth 40, as shown in FIG. 4, for example. The booth 40 is provided at the lower end of the lower extension tube 20. The booth 40 is provided such that an outlet of the lower extension tube 20 and an inlet of the booth 40 are connected to each other, and is preferably provided, for example, in close contact with the lower extension tube 20. The booth 40 may be integrally formed with the lower extension tube 20 or may be detachably provided to the lower extension tube 20. In the example of FIG. 4, the inlet of the booth 40 is wider than the outlet of the lower extension tube 20, and the booth 40 is provided so as to surround the fiber outlet 21 of the lower extension tube 20. The glass fiber 3 coming out from the fiber outlet 21 of the lower extension tube 20 continuously passes through the booth 40.

In the example of FIG. 4, the booth 40 has a rectangular parallelepiped shape extending in the propagating direction of the glass fiber 3. The booth 40 includes a first side surface 41 and a second side surface 42. The second side surface 42 is a surface facing the first side surface 41. The glass fiber 3 passes between the first side surface 41 and the second side surface 42. A supply opening 43 is provided in the first side surface 41. A discharge opening 44 is provided in the second side surface 42. The discharge opening 44 may be, for example, a slit whose opening size can be changed. The gas G2 is supplied from the supply opening 43 and discharged from the discharge opening 44. In other words, the supply opening 43 is provided to supply the gas G2 into the booth 40, and the discharge opening 44 is provided to discharge the gas G2 in the booth 40. In this manner, the gas G2 is supplied from the supply opening 43 to the discharge opening 44 so as to pass around the glass fiber 3 and blow out.

In the example of FIG. 4, a first end portion of a supply tube 43a is connected to the supply opening 43. A gas generation unit 45 is connected to a second end portion of the supply tube 43a. A first end portion of a discharge tube 44a is connected to the discharge opening 44. A second end portion of the discharge tube 44a is connected to the outside (not shown) of the drawing furnace 100.

The gas generation unit 45 is configured to generate the gas G2 and supply the generated gas G2 to the supply opening 43. In this example, the gas G2 may be an inert gas that is controlled so that the dew point temperature around the fiber outlet 21 is 10° C. or lower. The gas G2 may be dry air that is controlled so that the dew point temperature around the fiber outlet 21 is 10° C. or lower. The dry air is air in which the water vapor in the air is adsorbed by a desiccant and a content of the water vapor is reduced. The desiccant contains at least one of zeolite, silica gel, and refrigerator desiccant.

The gas G2 generated by the gas generation unit 45 is supplied through the supply tube 43a into the booth 40 from the supply opening 43 of the first side surface 41. The gas G2 supplied into the booth 40 is supplied around the glass fiber 3 passing through the booth 40. Further, the gas G2 supplied into the booth 40 is discharged from the discharge opening 44 of the second side surface 42 to the outside of the drawing furnace 100 through the discharge tube 44a. The gas generation unit 45 is an example of an inert gas generation unit.

In this way, the gas G2 is supplied into the booth 40 covering the fiber outlet 21. Therefore, the fiber outlet 21 of the lower extension tube 20 can be more effectively covered in an atmosphere with a dew point temperature of 10° C. or lower. Since the gas G2 is supplied from the supply opening 43 and discharged from the discharge opening 44, a flow of the gas G2 passing around the glass fiber 3 is formed in the booth 40. As a result, dust and gases such as dicyan ejected in the drawing furnace 100 is less likely to remain.

In the example of FIG. 4, the booth 40 is further provided with a plate 46 between the supply opening 43 and a position inside the booth 40 through which the glass fiber 3 passes. Specifically, the plate 46 extends along the propagating direction of the glass fiber 3 between the supply opening 43 and the glass fiber 3. The plate 46 may be supported directly or indirectly on the first side surface 41 or may be supported directly or indirectly on an upper surface of the booth 40. There is a cavity between the supply opening 43 and the plate 46. A length of the plate 46 in the propagating direction of the glass fiber 3 is longer than an opening length of the supply opening 43 in the propagating direction of the glass fiber 3. Further, the supply opening 43 is provided above a lower end of the plate 46 on the first side surface 41. According to such a configuration, the plate 46 prevents the gas G2 supplied from the supply opening 43 from directly hitting the glass fiber 3. That is, the gas G2 supplied into the booth 40 collides with the plate 46 and is diffused into the booth 40. As a result, deflection of the glass fiber 3 can be prevented.

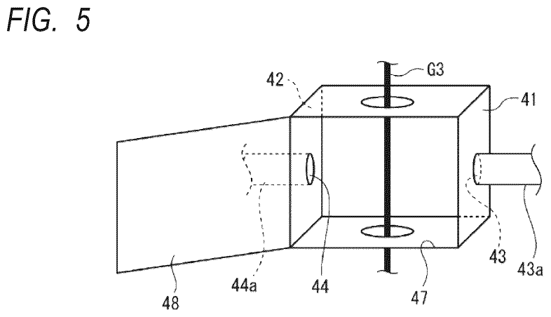

Further, the booth 40 may be provided with an opening and closing door 48 on a front surface 47 different from the first side surface 41 and the second side surface 42. FIG. 5 is a schematic perspective view of the booth 40. As shown in FIG. 5, the opening and closing door 48 is provided on the front surface 47 of the booth 40. According to such a configuration, an operator can open the opening and closing door 48 to check the inside of the booth 40, so that it is easy to initially draw a glass fiber from an optical fiber base material (so-called gob dropping work).

Although the present disclosure has been described in detail with reference to a specific embodiment, it is apparent to those skilled in the art that various changes and modifications can be made without departing from the spirit and scope of the present disclosure. In addition, the number, positions, shapes, and the like of the constituent members described above are not limited to the embodiment described above, and can be changed to the number, positions, shapes, and the like suitable for carrying out the present disclosure. The elements included in the above-described examples may be combined with each other.

The lower extension tube 20 may not include the shutter mechanism 26.

The gas purge tube 30 has a double pipe structure, and is not limited to this structure.

The gas G2 may be supplied around the fiber outlet 21 using a configuration other than the gas purge tube 30 and the booth 40.

A method of supplying the gas G2 around the fiber outlet 21 and a method of providing the booth 40 are shown. However, the fiber outlet 21 may be covered in an atmosphere with a dew point temperature of 10° C. or lower by using another method. For example, air conditioning in a room in which the optical fiber manufacturing device 1 is installed may be controlled so that the dew point temperature of the entire room becomes 10° C. or lower.

In addition to the drawing furnace 100, the cooling device, the coating device, and the winding device (all not shown), the optical fiber manufacturing device 1 may include, between the drawing furnace 100 and the cooling device, a slow cooling furnace that gradually lowers the temperature of the glass fiber 3 coming out from the drawing furnace 100. An inert gas or dry air may be supplied into the slow cooling furnace. The booth 40 may be provided between the drawing furnace 100 and the slow cooling furnace, or may be provided between the slow cooling furnace and the cooling device.

### REFERENCE SIGNS LIST

1: optical fiber manufacturing device
2: optical fiber base material
3: glass fiber
10: heating furnace
11: housing
12: core tube
13: heater
14: gas pipe
15: inert gas supply unit
16: gas inlet
20: lower extension tube
21: fiber outlet
22: gas suction opening
23a, 23b: gas pipe
24: gas regeneration device
25: pipe
26: shutter mechanism
261: upper shutter
261a: passage hole
262: lower shutter
263: gas recovery space
30: gas purge tube
31: gas inlet
32a, 32b: gas pipe
33: gas supply unit
34: outer wall
35: inner wall
40: booth
41: first side surface
42: second side surface
43: supply opening
43a: supply tube
44: discharge opening
44a: discharge tube
45: gas generation unit
46, plate
47: front surface
48: opening and closing door
100: drawing furnace
G1: mixed gas
G2: gas

What is claimed is:

1. An optical fiber manufacturing method comprising:
in a drawing furnace, heating and melting an optical fiber base material and drawing the optical fiber base material to form a glass fiber,
wherein the drawing furnace includes
a heating furnace configured to heat and melt an optical fiber base material, and
a lower extension tube provided at a lower end of the heating furnace and through which the glass fiber passes,
wherein the lower extension tube has a fiber outlet from which the glass fiber comes out, and
wherein drawing is performed while the fiber outlet is covered in an atmosphere with a dew point temperature of 10° C. or lower.

2. The optical fiber manufacturing method according to claim 1,
wherein the heating furnace has a gas inlet through which a gas containing helium gas is introduced into the heating furnace,
wherein the lower extension tube has a gas suction opening though which a gas containing helium gas in the lower extension tube is sucked out and discharged to the outside of the lower extension tube, and
wherein drawing is performed while the gas containing helium gas discharged from the gas suction opening is regenerated for reuse.

3. The optical fiber manufacturing method according to claim 1,
wherein a temperature of the glass fiber coming out from the fiber outlet is 1300° C. or more and 1700° C. or less.

4. The optical fiber manufacturing method according to claim 1,
wherein an inert gas is supplied around the fiber outlet.

5. The optical fiber manufacturing method according to claim 1,
wherein an inert gas is supplied into a booth surrounding the fiber outlet.

6. The optical fiber manufacturing method according to claim 5,
wherein the booth has a first side surface and a second side surface facing the first side surface, and
wherein the inert gas is supplied from the first side surface and is discharged from the second side surface.

7. An optical fiber drawing device that heats and melts an optical fiber base material and draws the optical fiber base material to form a glass fiber, the drawing device comprising:
a heating furnace configured to heat and melt the optical fiber base material;
a lower extension tube provided at a lower end of the heating furnace and through which the glass fiber passes and comes out from a fiber outlet;
a booth surrounding the fiber outlet and having a supply opening through which an inert gas is supplied into the booth; and
an inert gas generation unit configured to generate the inert gas and supply the generated inert gas to the supply opening.

8. The optical fiber drawing device according to claim 7,
wherein a plate is provided between the supply opening and a position inside the booth though which the glass fiber passes.

9. The optical fiber drawing device according to claim 7,
wherein an opening and closing door is provided on a front surface of the booth.
